(19) United States
(12) Patent Application Publication
(10) Pub. No.: US 2008/0214252 A1
(43) Pub. Date: Sep. 4, 2008

(54) Handheld electronic keypad access case

(76) Inventors: Remzi Oten, Irvine, CA (US); Fevzi Oten, Tustin, CA (US)

Correspondence Address: PHILIP H. HAYMOND, 7545 IRVINE CENTER DRIVE, SUITE 200, IRVINE, CA, 92618-2933, US

(21) Appl. No.: 11/974,509

(22) Filed: Oct. 12, 2007

Related U.S. Application Data
(60) Provisional application No. 60/851,524, filed on Oct. 13, 2006.

(51) Int. Cl. H04M 1/00

(52) U.S. Cl. 455/575.8

(57) ABSTRACT

A case for a hand-held electronic device such as a cell phone, having a movable full or semi-covering that covers the data-entry utility of the hand-held electronic device when closed. The display portion of the hand-held electronic device is continuously covered with a transparent sheet, providing full protection of the display, while the movable cover portion of the case can be moved from a first open position, allowing direct access to the data entry portion, to a second closed position, covering and protecting the data-entry portion.

### RELATED APPLICATIONS

This application hereby incorporates by reference and claims the priority and filing date of U.S. provisional patent application Ser. No. 60/851,524, Remzi Oten and Fevzi Oten inventors, filed Oct. 13, 2006, entitled Handheld Electronic Keypad Access Case.

### FIELD OF THE INVENTION

This invention relates to accessories for handheld electrical apparatus more particularly to a case for protecting a handheld electronic devices having a screen and a data entry utility, such as a cellular telephone with a keypad.

### BACKGROUND OF THE INVENTION

There are a number of popular handheld electronic devices in use that have both a screen and a data entry portion such as a keypad on one side of the device. Examples of these devices are Personal Digital Assistants, referred herein to as PDAs, cellular telephones, handheld electronic games such as a certain Game Boy® electronic video games made by the Nintendo Company, Ltd., of Kyoto, Japan. Cellular or mobile telephones are used by way of example in this is application but the methods and apparatus described herein refer equally to all such handheld electronic devices including all those having a screen and a data entry utility such as a keypad.

Mobile cellular telephones and other handheld electronic devices come in several different physical styles, also known as form factors. While manufacturers are continually devising types of designs, there are several common categories used on this site to describe form factors. The bar configuration of a handheld electronic device 10, shown in FIG. 1, here a mobile cellular telephone, sometimes referred to as candy bar or block configuration, is a most basic style. This cellular telephone is a monolithic structure with no moving parts in the case itself, aside from buttons and possibly an antenna 12. Unless the bar configuration is used with a case 14 the screen display 16 and data entry utility 18, here a keypad, are exposed to the environment. Other openings 11 may be provided for jacks, a microphone or a speaker.

Clamshell, flip or sliding type cellular telephones consist of two halves connected by a movable joint such as a hinge or track. The telephone folds from an open to a closed position when not in use. In the open position the upper half usually contains a speaker and the display while the lower half contains the data entry keypad and a microphone. Generally the two halves cover each other for protection of the display and data entry portion while not in use. Sliding or swiveling types of cellular telephones have two halves akin to the flip form factor, but they either slide or swivel past each other rather than use a hinge.

The above configurations of handheld electronic devices can be combined with several different types of data entry utilities, the most common of which is a ten-key keypad for dialing telephone numbers. The data entry utility may also include a button for moving a cursor about various menus displayed on the display. A four-way directional button is a large key on the keypad that scrolls the cursor on the screen in one of four directions, plus push down to ENTER to select an item and to navigate through menu items or list items. A joystick may be used as well, a joystick is a short button that protrudes from the keypad that operates similarly to a four-way button except that diagonal cursor movement is often easier. Joysticks are generally better for graphical activities such as playing games or navigating the Internet. The data entry utility or portion of the handheld electronic device may include a track wheel too, which is used as a thumb-wheel or scroll-wheel. These are generally mounted on the side edge of the body of the handheld electronic device and the thumb or forefinger is used to scroll through the menus.

With respect to Personal Digital Assistants and to handheld electronic games, a QWERTY keyboard may be included in the data entry portion as well. A Qwerty keyboard is a typewriter keyboard. A QWERTY keyboard usually makes the handheld device much larger, depending on key spacing, but in a handheld electronic device almost always requires very small individual keys.

Touch-sensitive screens are also used for data entry. Touch-sensitive screens use a pen or stylus to control the cursor on the screen. Touch-sensitive screens display a graphical keyboard or other icons to allow data entry.

Handheld electronic devices having a screen and a data entry utility are for the most part delicate and sophisticated devices that should be protected from dirt, shock and the elements in the environment by using a case to enshroud the handheld device. The screen portion and the data entry display portion have different needs for exposure to the environment however. There is usually less need to access the screen because it need only be viewed and, except for touch screens, does not need to be touched as the data entry portion does. The display screen therefore can be covered with a transparent sheet and still perform its intended function.

The data entry utility such as a keypad however is usually a set of mechanical buttons or other device as described above that optimally requires direct touch by a user. Some Yet the data entry utility can be damaged by dirt and dust or otherwise frequently exposed to the environment.

In the prior art handheld electronic devices 10 have simply been contained in a pouch and removed when needed. Cases have also been used in the prior art that include a transparent sheet 19 that covers both the screen and the data entry utility. This configuration however, causes difficulty for a user attempting to operate the data entry utility device, noted above, because the keys are small and the transparent sheet interferes with efficiently poking the buttons, moving knobs, etc. The restrictions imposed by having to depress button, move knobs or touch screens makes these utilities more difficult to use and results in more mis-entries of data input by a user. Cellular telephone key pads for example have very small buttons used to enter a telephone number and having to depress them through the transparent sheet 19 material is more difficult because it deprives the user of much tactile sensing in feeling the individual keys.

The problem with cases of the prior art then is that the access and protection needs for the data entry utility and the display screen are very different if not opposite. The display screen is best cared for with constant protection such a transparent covering, otherwise it may become scratched or dirty and a user will no longer be able to see the display clearly. Conversely, the data entry portion of the hand-held device has basically opposite exposure requirement, a user must constantly access the keys, joystick, directional button, etc. in order to operate the device and the more direct the contact the easier it is to manipulate these devices. Covering the data entry portion occludes access to the keys.

The data entry portion does have a need for a cover when the device is in not in use however. The keys can become dirty or damaged if exposed to the elements and should best be sequestered when not in use. Moreover, otherwise the keys can be accidentally depressed when not in use, for example to activate a cellular telephone to make expensive telephone calls while being carried in a purse or a pocket.

What is needed then is a case for a hand held electronic device with a configuration that both constantly protects the screen portion of such a device but also allows full access to the data entry utility, and that will protect the data entry utility when not in use.

### SUMMARY OF THE INVENTION

A solution to the above has been devised. In the preferred embodiment a case for a hand-held electronic device such as a cell phone, having a movable full or semi-covering that covers at least the data-entry utility of the hand-held electronic device when closed. The display portion of the hand-held electronic device is continuously covered, providing full protection of the display, while the movable portion of the case can be moved from a first open position, allowing direct access to the data entry portion, to a second closed position, covering the data-entry portion of the hand-held electronic device.

### BRIEF DESCRIPTION OF THE DRAWINGS

FIG. 1 is a diagram of a candy bar or block configuration of a cellular telephone of the prior art

FIG. 2 is a perspective view of a case of the present invention that includes a movable cover for covering the data entry utility.

FIGS. 3A and 3B are side views of a case of FIG. 2 showing the cover in first open position and a second closed position.

FIGS. 4A and 4B are side views of a case of the preferred embodiment showing the cover in first open position and a second closed position, covering both the data entry utility and the display screen when in the closed position.

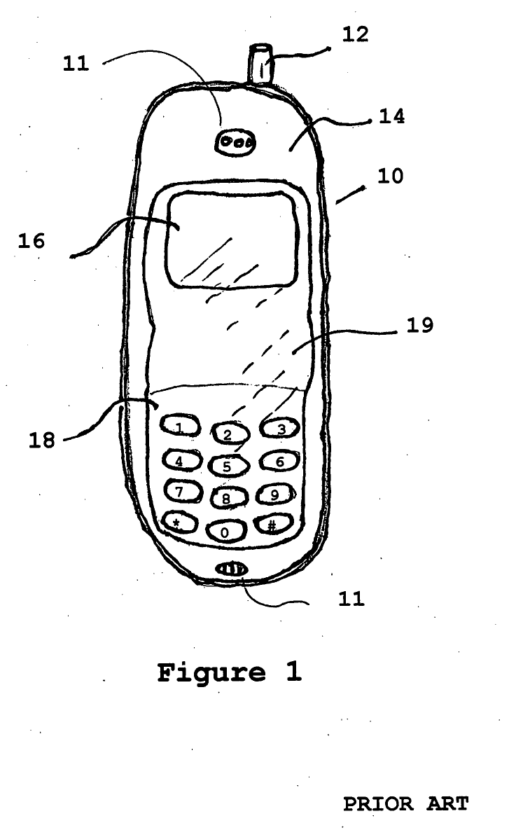

### DESCRIPTION OF THE INVENTION

The following description and the figures to which it refers are provided for the purpose of describing examples and specific embodiments of the invention only and are not intended to exhaustively describe all possible examples and embodiments of the invention.

FIG. 2 is a front view of one embodiment of the present invention. A case 20 for holding a bar form of hand-held electronic device 10 (partially in dotted outline), here a cellular telephone, is shown. The case 20 has a body portion 22, a transparent sheet portion 24 and an opening or void 26 adapted to allow direct contact of a user's finger tips with the data entry utility 18 of a hand-held electronic device 10. The transparent sheet portion 24 of the case 20 is adapted to cover at least a portion the display 16 of the hand-held electronic device 10. The transparent portion 24 of the present invention may be a sheet of transparent or translucent plastic, this and the other materials used to make this configuration of a handheld electronic device case will be known to those of skill in the art.

The body portion 22 of the device covers the handheld electronic device 10 at least sufficient to affix the case 20 to the handheld electronic device, covering only portions or all of those areas of the device 10 that are not covered by the transparent sheet 24 or the opening 26. The body 22 will usually cover most or all of the balance of the device 10.

The transparent sheet portion 24 is adapted to cover the screen display portion 16 of the hand-held electronic device 10 and optionally other parts of the hand-held electronic device, except for the data entry utility 18. The cover 28 is movably attached to the body 22, in this example it is attached in a hinged manner at hinge area 30.

Handheld electronic devices 10 come in various shapes and sizes so the body 22 of the case must be adapted to so that the transparent cover 24 fits over the display 16 of a given a handheld electronic device 10 when the case 20 is placed over a given handheld electronic device and the opening 26 must also be sized to allow the desired contact with the data entry utility used for a particular model handheld electronic device 10. The methods for adapting the sizing of a case to a given handheld electronic device is known to those of skill in the art.

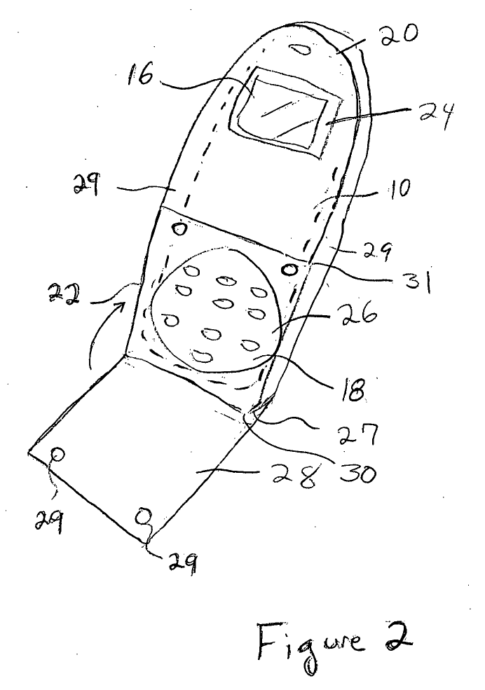

At the lower end of the device 10 adjacent the opening 26 the case 20 includes a cover 28 that is movably attached to the case. In the depicted embodiment this cover 28 is shown as a flap that extends from the rear of the case 20 on the side opposite the display utility, forming a second opening 27 to insert the electronic into the case. The cover 28 is effectively hingeably attached to the case 20, allowing it to be moved from an closed position to an open position, as shown in FIGS. 3A and 3B, to a point 31 where it covers the data entry utility 18. Complementary clasps 29 are provided on the body 20 and the cover 28 to secure the flap in a closed position. The clasps 29 shown are mutually attracting magnets embedded in the case that will hold the cover closed when it is moved to a closed position (arrow shows direction) but could also for example be snaps, hook-and-loop material or other equivalent connector. While the movably attached cover 28 shown is as a flap for illustration, a cover may be movably attached by other methods known to those of skill in the art, for example such as with a pivot, a sliding cover held within tracks or with, separate mechanical hinges to affix the cover to the body. In all cases the cover 28 is fashioned to allow it to remain affixed to the body 20 when it is positioned to uncover the data entry utility 18. The cover 28 is shown in a first, open position here and also in FIG. 3A.

In the preferred embodiment the body 22 and the cover 28 are made from a single unitary piece of material such as leather or plastic, sewn together into an open-ended box to allow insertion of the handheld electronic device 10 at one end 27 and to allow the flap to bend over the one end and to cover the data entry utility portion 18 and display portion 16 of the handheld electronic device 10.

The cover 28 is shown in a second, closed position in FIG. 3B where the cover has been moved (indicated by arrows) from the first open position of FIG. 3A and may again be opened to the first position of FIG. 3A. Retaining clasps 29 keep the cover in a closed position, which may be hooks, snaps or, as is presently preferred, with magnets embedded in the body portion 22 and cover 28.

The cover movably covers the data entry portion 18 of the hand-held electronic device 10 while in a second closed of FIG. 3B, protecting the mechanical buttons of the handheld electronic device 10. When the cover 28 is again moved to the first position of FIG. 3A, the data entry utility 18 of the handheld electronic device 10 is exposed and accessible to be operated by a user by direct touch.

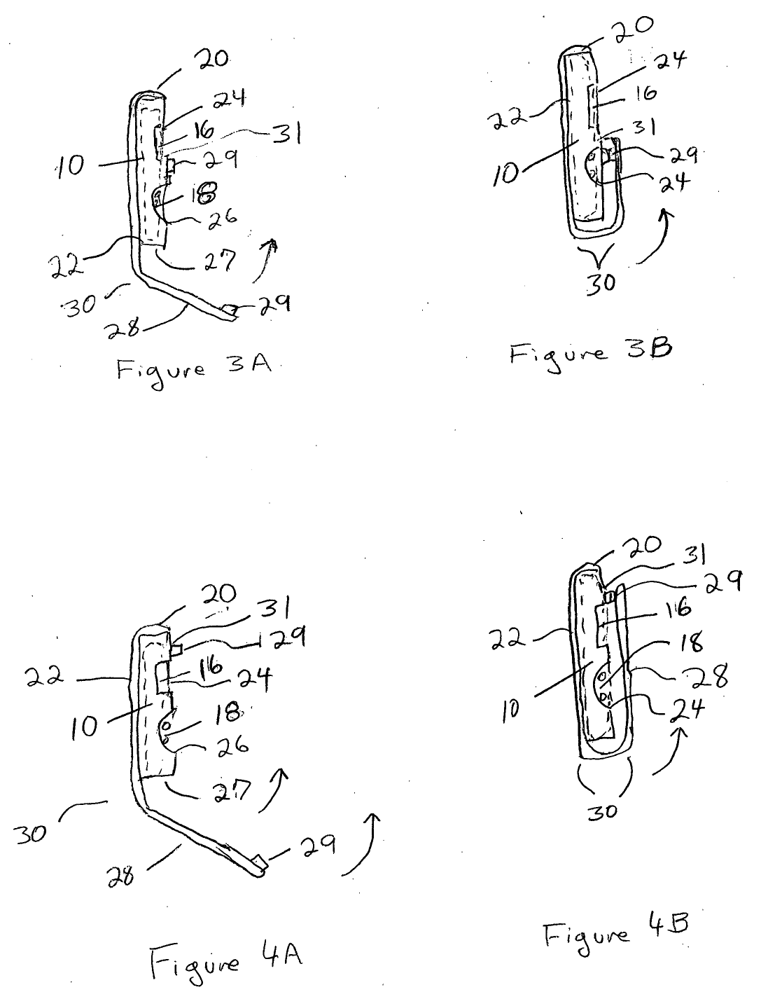

FIGS. 4A and 4B show the same case 20 of FIGS. 3A and 3B however the cover 28 is longer and extends further up the body 22 of the case to also cover the screen display 16 when closed. In this preferred embodiment when the cover 28 is moved (direction indicated by arrow) to the closed position of FIG. 4B, the cover 28 also covers the display by meeting the body 22 of the case at a different point 31, above the screen display 16. In this way additional protection is afforded the screen display 16.

The methods of the present invention includes the steps of providing a handheld electronic case of the present invention, described above, inserting a handheld electronic device 10 and covering at least the data entry utility 18 that the electronic device.

It will be appreciated that the invention has been described hereabove with reference to certain examples or preferred embodiments as shown in the drawings. Various additions, deletions, changes and alterations may be made to the above-described embodiments and examples without departing from the intended spirit and scope of this invention.

Accordingly, it is intended that all such additions, deletions, changes and alterations be included within the scope of the following claims.

What is claimed is:

1) A case for a handheld electronic device having a face side that includes both a screen and a data entry utility, a back side opposite the face side, and top, bottom, left, and right sides relative the face side extending between the face and back side, comprising:
a first front portion adapted to be affixed to the handheld electronic device and substantially cover the face side of the handheld electronic device, said first portion having one or more openings adapted to allow a user to view the screen and to directly touch the data entry utility, and
a flap extending from or movably attached to the case, said flap being adapted to be placed in a first position wherein the flap covers the data entry utility without covering the screen, and to be moved to a second position to uncover the data entry utility.

2) The case of claim 1 further including a transparent sheet, said sheet covering some or all of the one or more openings but herein the transparent sheet does not cover the data entry utility.

3) The case of claim 1 where the movable flap extends from or is movably attached to the front portion.

4) The case of claim 1, where the case further includes a rear portion that is connected to the first portion and covers some or all of a back side of the handheld electronic device located opposite the face side.
